(19) United States
(12) Patent Application Publication
(10) Pub. No.: US 2019/0358653 A1
(43) Pub. Date: Nov. 28, 2019

(54) Cyclone Filtering Device

(71) Applicant: Everinn International Co., Ltd., Taichung City (TW)

(72) Inventor: Yu-Pei Ho, Taichung City (TW)

(21) Appl. No.: 15/986,928

(22) Filed: May 23, 2018

(51) Int. Cl. B04C 7/00; F04D 29/28; B04C 3/00; B04C 5/185; B01D 45/16

(52) U.S. Cl. CPC B04C 7/00; F04D 29/281; B04C 2009/004; B04C 5/185; B01D 45/16; B04C 3/00

(57) ABSTRACT

A cyclone filtering device includes first and second filters. The first filter includes a first filtering tube defining a first turbulence room, and has a coupling cover communicated with the first turbulence room and disposed for allowing passage of fluid, and a barrel seat defining a dust collecting room that is communicated with the first turbulence room. The second filter includes a second filtering tube defining a second turbulence room that is communicated with the first turbulence room, two end covers having an end opening that is communicated with the second turbulence room, and a capture member disposed in the second turbulence room and disposed for capturing substances that are entrained in the fluid.

### FIELD

The disclosure relates to a filtering device, and more particularly to a cyclone filtering device.

### BACKGROUND

Referring to FIG. 1, a conventional filtering device 1 includes a filtering tube 11 defining a turbulence room 110, a top cover 12 connected to a top end of the filtering tube 11, a bottom cover 13 connected to a bottom end of the filtering tube, and an impeller 14 connected between the top cover 12 and the filtering tube 11. The top cover 12 has an inlet opening 121 and an outlet opening 122 that are opposite to each other, and that are in communication with the turbulence room 110.

In use, when a fluid (as indicated by solid arrows in FIG. 1) entraining substances (e.g., impurities, powder, or dust) flows into the turbulence room 110 of the filtering tube 11 from the inlet opening 121 of the top cover 12, the substances are separated from the fluid by a centrifugal force which is generated from an air vortex, and drop along an inner wall of the filtering tube 11 and accumulate in the bottom cover 13 by virtue of gravity. Then, the filtered fluid flows out of the filtering tube 11 and the top cover 12 through the outlet opening 122.

However, the conventional filtering device 1 is only suitable for separation of substances that have sufficient weight and size, relatively small and light substances may not be effectively filtered out from the fluid.

### SUMMARY

Therefore, an object of the disclosure is to provide a cyclone filtering device that can alleviate at least one of the drawbacks associated with the abovementioned prior art.

Accordingly, the cyclone filtering device includes a first filter and a second filter. The first filter includes a first filtering tube, a coupling cover, a barrel seat, and an impeller. The filtering tube defines a first turbulence room, and has two opposite first end portions. The coupling cover removably covers the first filtering tube. The barrel seat is disposed for the first filtering tube to extend thereinto. The impeller is mounted between the first filtering tube and the coupling cover. The coupling cover is removably connected to one of the first end portions of the first filtering tube, and has two cover openings that are communicated with the first turbulence room, and that are disposed for allowing passage of fluid. The barrel seat defines a dust collecting room that is communicated with the first turbulence room. The other one of the first end portions of the first filtering tube extends into the dust collecting room. The second filter is connected to the first filter. The second filter includes a second filtering tube, two end covers, and a capture member. The second filtering tube defines a second turbulence room communicated with the first turbulence room and has two opposite second end portions. The end covers removably and respectively cover the second end portions of the second filtering tube. The capture member is disposed in the second turbulence room of the second filtering tube, and has a plurality of filtering nets dispsoed for capturing substances which are entrained in the fluid. Each of the end covers has an end opening that is communicated with the second turbulence room.

### BRIEF DESCRIPTION OF THE DRAWINGS

Other features and advantages of the disclosure will become apparent in the following detailed description of the embodiments with reference to the accompanying drawings, of which:

FIG. 1 is a sectional view of a conventional filtering device;

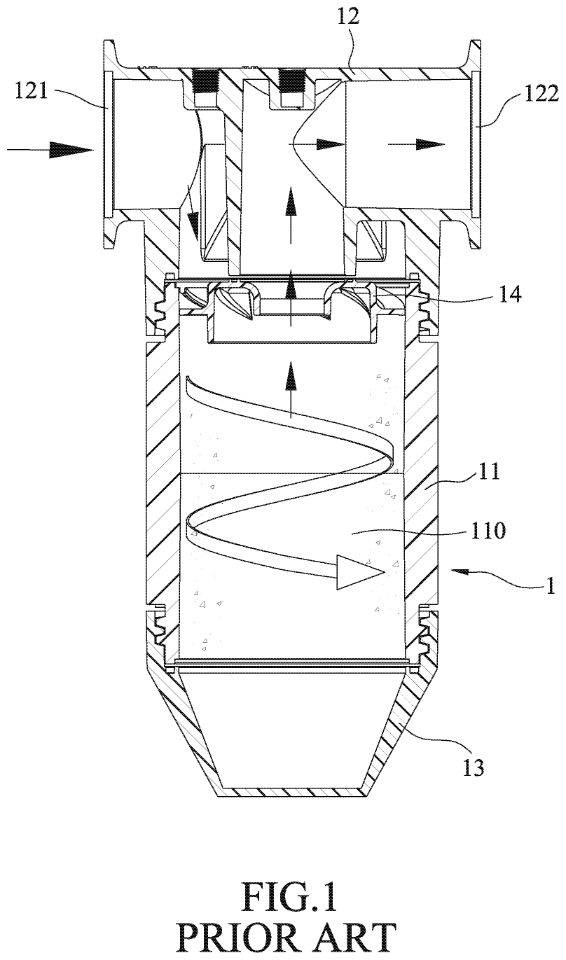

FIG. 2 is a perspective view of a first embodiment of a cyclone filtering device according to the present disclosure;

FIG. 3 is a perspective view of an air pressure unit of the first embodiment;

FIG. 4 is a fragmentary exploded perspective view of a first filter, a second filter, and a connecting unit of the first embodiment;

FIG. 5 is a fragmentary sectional view of the first filter, the second filter, and the connecting unit of the first embodiment;

FIG. 6 is another fragmentary sectional view of the first embodiment, illustrating substances entrained in fluid being filtered by the first filter;

FIG. 7 is still another fragmentary sectional view of the first embodiment, illustrating substances entrained in the fluid being filtered by the second filter;

FIG. 8 is a side view of a second embodiment of the cyclone filtering device according to the present disclosure;

FIG. 9 is a partly exploded perspective view of a third embodiment of the cyclone filtering device according to the present disclosure;

FIG. 10 is an assembled perspective view of the third embodiment.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

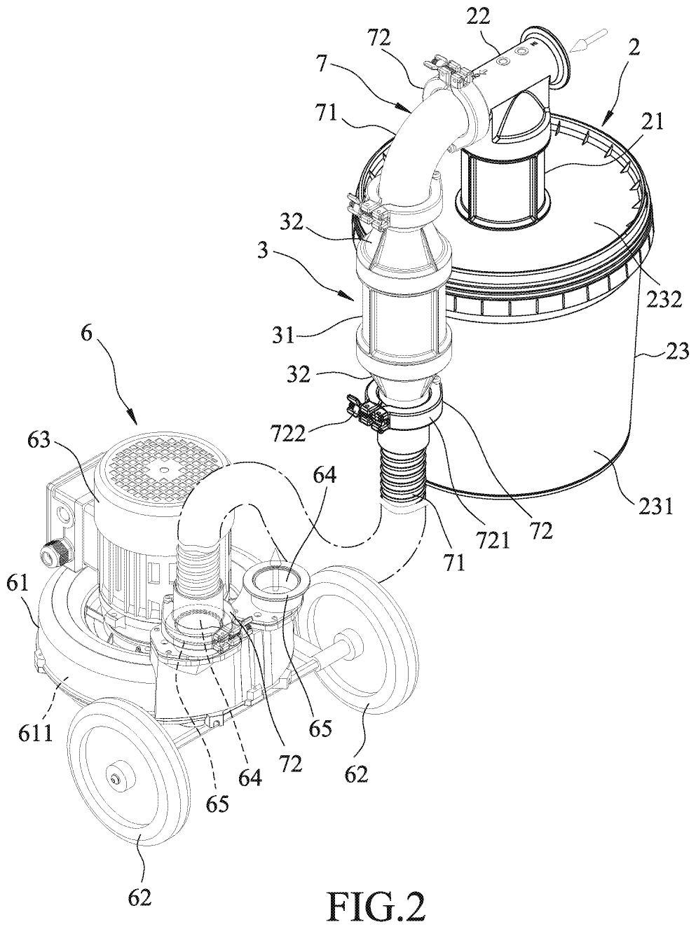

Referring to FIGS. 2 to 4, a first embodiment of a cyclone filtering device according to the disclosure includes a first filter 2, a second filter 3, an air pressure unit 6, and a connecting unit 7.

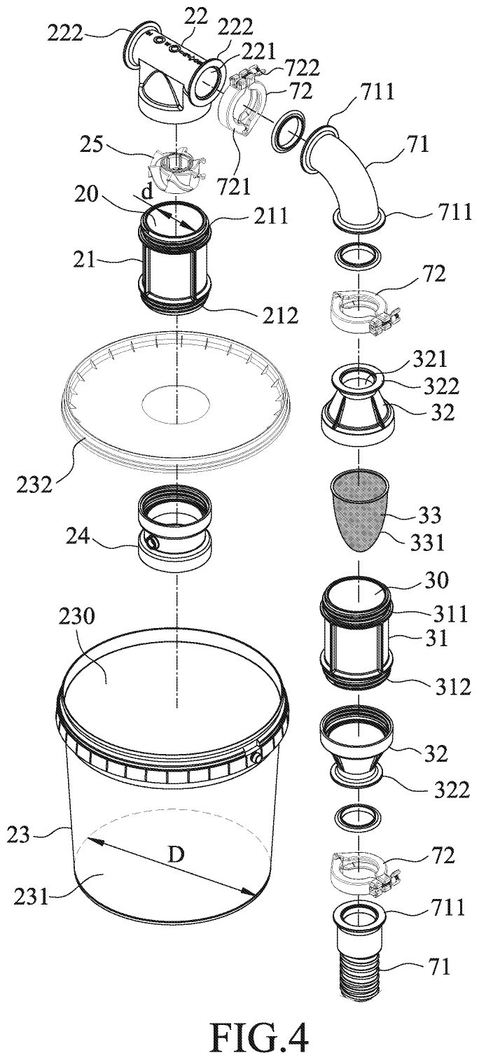

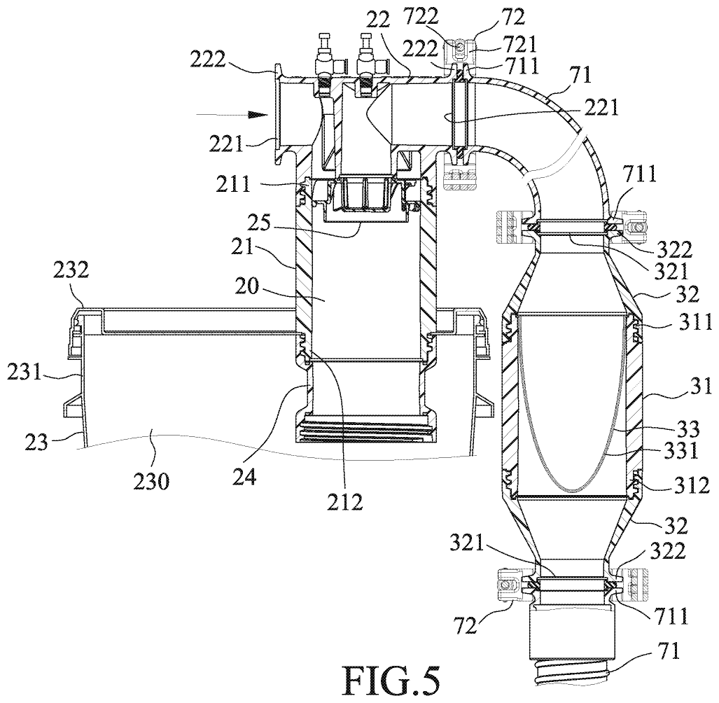

The first filter 2 includes a first filtering tube 21, a coupling cover 22, a barrel seat 23, an annular dust output member 24, and an impeller 25. The first filtering tube 21 defines a first turbulence room 20 and has two opposite first end portions 211, 212. In this embodiment, the coupling cover 22 removably covers the first filtering tube 21, and is removably connected to the upper first end portion 211 of the first filtering tube 21. The coupling cover 22 has two opposite first flanges 222 respectively defining two cover openings 221 that are communicated spatially with the first turbulence room 20 and that are disposed for allowing passage of a fluid (e.g., air, water). The barrel seat 23 includes a barrel body 231 defining a dust collecting room 230 that is communicated with the first turbulence room 20, and a barrel cover 232 removably connected to the barrel body 231, and disposed for allowing the first filtering tube 21 of the first filter 2 to extend therethrough. Referring to FIG. 5, the lower first end portion 212 of the first filtering tube 21 extends into the dust collecting room 230 of the barrel seat 23 through the barrel cover 232. Referring to FIG. 4, a minimum diameter (D) of the barrel body 231 of the base seat 23 is larger than a maximum diameter (d) of the first filtering tube 21.

The dust output member 24 is connected to the lower first end portion 212 of the first filtering tube 21 which extends into the dust collecting room 230, and is communicated with the dust collecting room 230. The impeller 25 is mounted between the first filtering tube 21 and the coupling cover 22, and is disposed for separating the fluid and the substances entrained in the fluid, so as to drive the substances to move in a substance-moving direction which is opposite to a fluid-flowing direction of the fluid.

The second filter 3 includes a second filtering tube 31, two end covers 32 opposite to each other, and a capture member 33. The second filtering tube 31 defines a second turbulence room 30 communicated with the first turbulence room 20, and has two opposite second end portions 311, 312. The end covers 32 cover removably and respectively the second end portions 311, 312 of the second filtering tube 31. Each of the end covers 32 has a second flange 322 defining an end opening 321 that is communicated with the second turbulence room 30. The capture member 33 is disposed in the second turbulence room 30 of the second filtering tube 31, and is disposed for allowing for flow of the fluid therethrough. The capture member 33 has a plurality of filtering nets 331 disposed for capturing substances which are entrained in the fluid.

In this embodiment, the air pressure unit 6 is configured as a blowing machine. The air pressure unit 6 includes an annular seat 61, a plurality of wheels 62 disposed on the annular seat 61 and disposed for movement of the air pressure unit 6, a motor 63 mounted to the annular seat 61 and di sposed for generating suction force to draw the fluid, and two opening flanges 65 respectively defining two air openings 64 that are disposed for allowing the passage of the fluid. The annular seat 61 has a passage 611 communicated with the air openings 64. Each of the air openings 64 is communicated with a selected one of the cover openings 221 of the coupling cover 22 and the end opening 321 of a corresponding one of the end covers 32.

In this embodiment, the connecting unit 7 is disposed for connecting the second filter 3 to the first filter 2. The connecting unit 7 includes a plurality of connecting tubes 71 and a plurality of coupling members 72. Each of the connecting tubes 71 has two connecting tube flanges 711 that are respectively formed at two opposite ends thereof. Each of the coupling members 72 has a C-shaped ring 721 and a fastening portion 722 connected to the C-shaped ring 721 and operable for locking two opposite ends of the C-shaped ring 721 together.

In this embodiment, when assembling the first filter 2 to the second filter 3, one of the connecting tubes 71 is placed between the coupling cover 22 and one of the end covers 32 with the connecting tube flanges 711 respectively abutting against a corresponding one of the first flanges 222 and an adjacent one of the end second flanges 322. Then, one of the coupling members 72 is connected between one of the connecting tube flanges 711 of the corresponding one of the connecting tubes 71 and the corresponding one of the first flanges 222, and another one of the coupling members 72 is connected between one of the connecting tube flanges of the corresponding one of the connecting tubes 71 and the adjacent one of the second flanges 322 of the end covers 32, so as to achieve spatial communication of the first and second turbulence rooms 20, 30.

Afterwards, another one of the connecting tubes 71 is placed between the other one of the end covers 32 and the air pressure unit 6 with the connecting tube flanges 711 thereof respectively abutting against the second flange 322 of the other one of the end covers 32 and a corresponding one of the opening flanges 651. At this time, one of the coupling members 72 is connected between the connecting tube flanges 711 of the another one of the connecting tubes 71 and the corresponding one of the opening flanges 65, such that the second filter 3 and the air pressure unit 6 are coupled together.

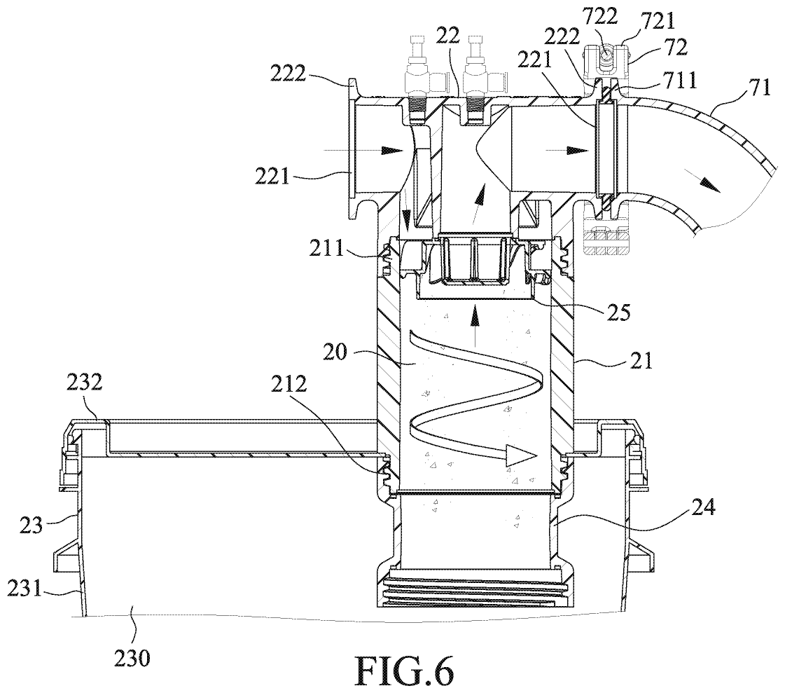

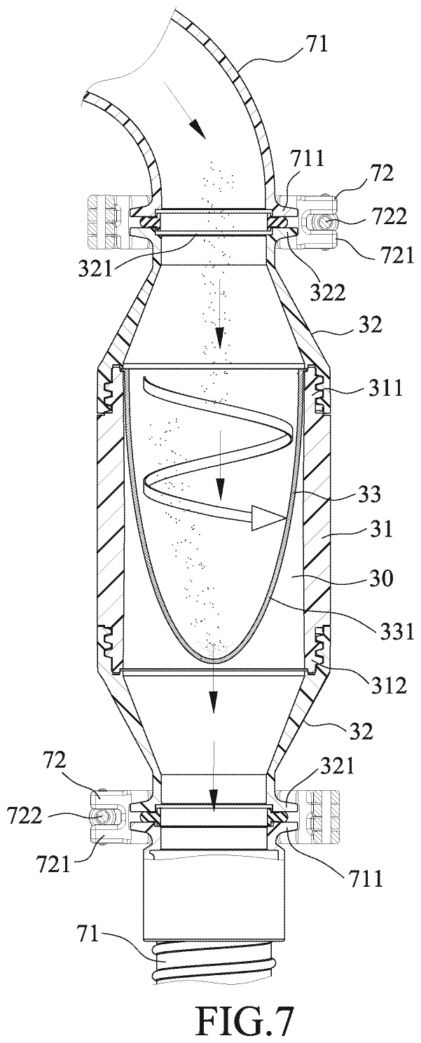

In use, referring to FIGS. 2, 5, 6 and 7, the fluid sequentially flows through the first filter 2, the second filter 3, and into the air pressure unit 6. Specifically, when the fluid (as indicated by solid arrows in FIG. 6) including substances (such as impurities, dust or powder) flows from one of the cover openings 221 of the coupling cover 22 into the first turbulence room 20 of the first filtering tube 21, the fluid flows vortically along the first filtering tube 21 with a portion of the substances that is larger and heavier being separated from the fluid by a centrifugal force and dropping along an inner wall of the first filtering tube 21 into the dust collecting room 230 of the barrel seat 23.

With the presence of the impeller 25, substance-moving direction of the substance and the fluid-flowing direction of the fluid are opposite, which can facilitate the separation of the substance from the fluid. Besides, due to the capture member 33, the remaining portion of the substances that is smaller in size and lighter is trapped by the filtering nets 331. Afterwards, the filtered fluid flows sequentially through the end opening 321 of a corresponding one of the end cover 32, a corresponding one of the connecting tubes 71, and a corresponding one of the air openings 64 into the passage 611 of the annular seat 61, and is finally exited via another one of the air openings 64.

In addition, when the first embodiment of the cyclone filtering device of the present disclosure is used, a fluid mixed with at least one of thick liquid, charged particles, and magnetic particles may be infused into the first turbulence room 20 of the first filter 2 from the coupling cover 22, so that such mixtures attached to the substances of the fluid increase the size and weight of the substances, thereby facilitating the accumulation of the substances in the dust collecting room 230 of the barrel seat 23.

The operator only needs to separate the barrel body 231 from the barrel cover 232 when intending to remove the substance from the dust collecting room 230, and separate the end covers 32 from the second filtering tube 31 for cleaning the substance accumulated on the filtering nets 331.

It should be noted that the portion of the substances that is larger and heavier is filtered and accumulated in the dust collecting room 230 instead of being captured by the capture member 33, which would not be required for frequent removal of the substances, so that the filtering nets 331 of the capture member 33 has a longer serving life. Furthermore, the abovementioned mixture which increases the size and weight of the remaining substances can facilitate the capturing effect of the capture member 33. Besides, in other embodiments, the second filter 3 may include a plurality of capture members 33 overlapping each other for enhancing blockage of the substances.

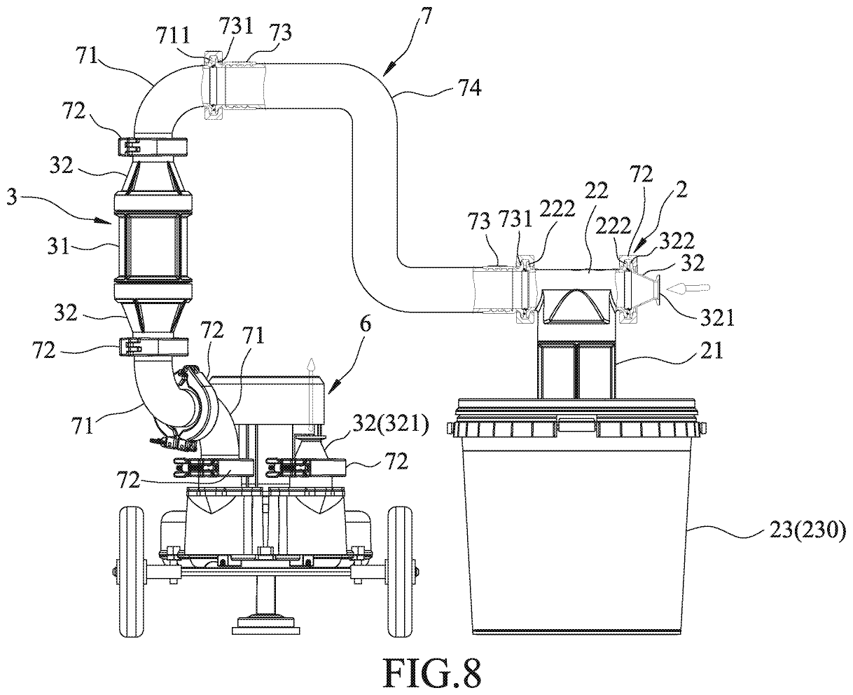

Referring to FIGS. 2, 3 and 8, a second embodiment of the cyclone filtering device has a structure similar to that of the first embodiment. The main difference between the second embodiment and the first embodiment resides in the following.

In this embodiment, the second filter 3 includes a plurality of end covers 32. The connecting unit 7 further includes a plurality of coupling tubes 73, and a plurality of extending tubes 74. Each of the coupling tubes 73 has a coupling tube flange 731 formed at one end thereof.

Each of the extending tubes 74 has two extending tube flanges 741 formed at two opposite end thereof and respectively connected to two coupling tubes 73. Each of the coupling members 72 is connected between the coupling tube flange 731 of one of the coupling tubes 73 and an adjacent one of the extending tube flanges 741 of the extending tubes 74, or is connected between the coupling tube flange 731 of one of the coupling tubes 73 and an adjacent one of the first flanges 222 of the coupling cover 22.

In this embodiment, the fluid flows from the end opening 321 of a corresponding one of the end cover 32 into the first filter 2. After passage of the fluid through the first and second filters 2, 3, the substances are filtered and separated from the fluid, and then the filtered fluid passes through the passage 611 of the annular seat 61 and finally flows out via a corresponding one of the air openings 641.

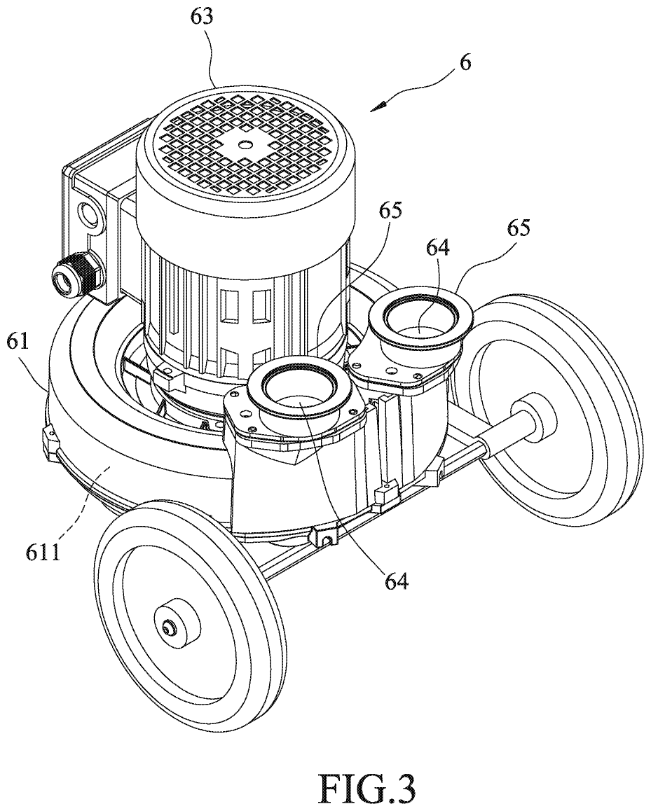

Referring to FIGS. 3, 9, and 10, a third embodiment of the cyclone filtering device has a structure similar to that of the second embodiment. The main difference between the third embodiment and the second embodiment resides in the following.

In this embodiment, the cyclone filtering device further includes a supporting frame unit 8. The connecting unit 7 further includes a plurality of three-way tubes 75. Each of the three-way tubes 75 has three-way tube flanges 751 respectively formed at three ends thereof. The supporting frame unit 8 includes a holding member 81, a handle 82, and a plurality of plugs 83. The holding member 81 is mounted onto the connecting unit 7, and that is disposed for holding the barrel seat 23 such that the barrel seat 23 is disposed above the air pressure unit 6. The handle 82 is connected to the holding member 81. Each of the plugs 83 has a plug flange 831 and a plug body 832. The holding member 81 is disposed around and abuts against the plug bodies 832 of the plugs 83.

Each of the coupling members 72 is connected between one of the three-way tube flanges 751 of the three-way tubes 75 and an adjacent one of the extending tube flanges 741 of the extending tubes 74, is connected between the plug flange 831 of one of the plugs 83 and an adjacent one of the extending tube flanges 741 of the extending tubes 74, and is connected between the plug flange 831 of one of the plugs 83 and an adjacent one of the three-way tube flanges 751 of the three-way tubes 75.

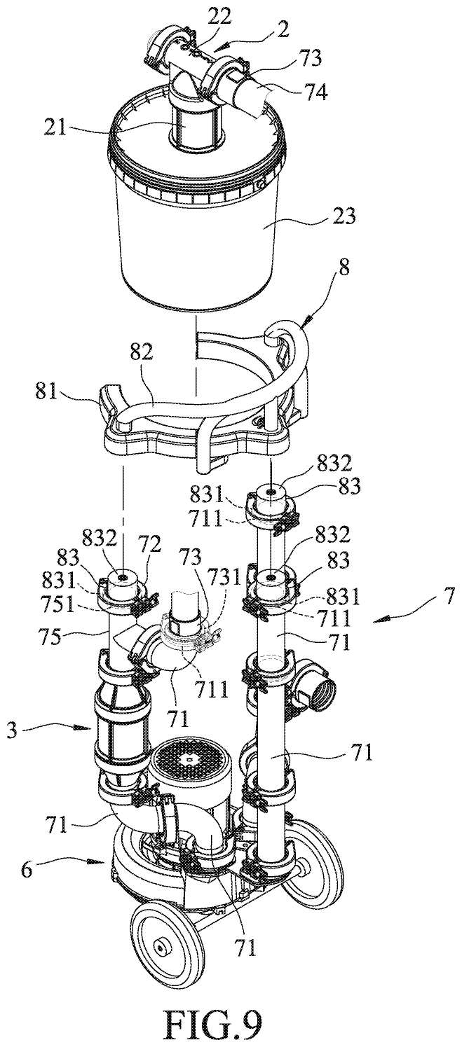

It should be noted that, in this embodiment, the supporting frame unit 8 has three plugs 83 (only two are visible in FIG. 9), and each of the plugs 83 is plugged into a corresponding one of the connecting tube flanges 711 of the connecting tubes 71 for blockage of the fluid.

By virtue of such disposition of the third embodiment of the cyclone filtering device according to the present disclosure, the fluid flows into the first filter 2 from a corresponding one of the coupling tubes 73, and after separation of the substances by the first and second filters 2, 3, the filtered fluid flows through the passage 611 of the annual seat 61 into a corresponding one of the air openings 64, and is finally exited from a corresponding one of the coupling tubes 73.

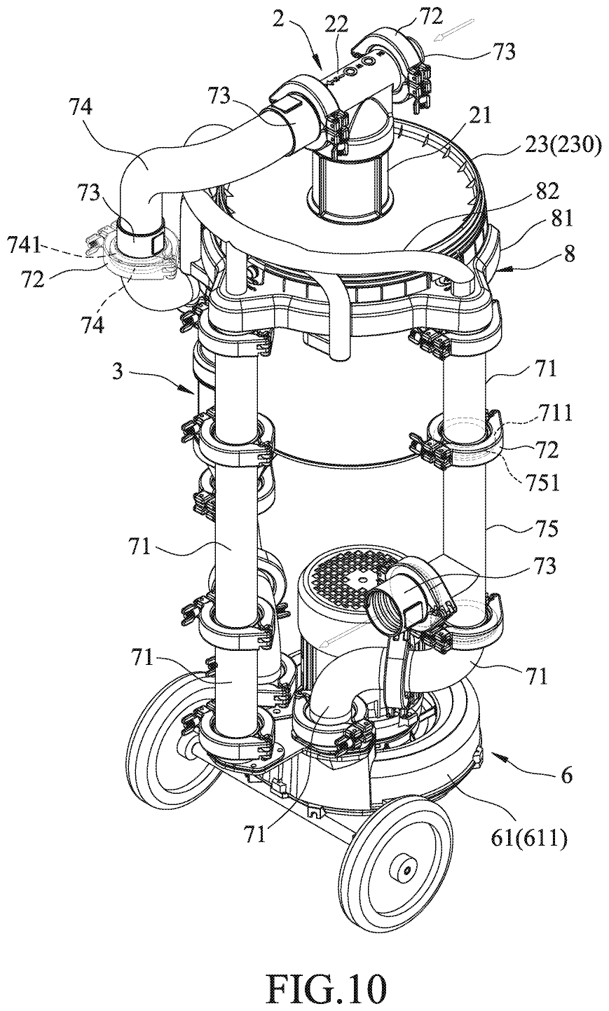

Further referring to FIG. 10, since the connecting tubes 71 and the three-way tubes 75 cooperate with the holding member 81 to serve as three supporting holders that extend in an upright direction, the barrel seat can be securely disposed above the air pressure unit 6, thereby allowing easy movement of the barrel seat 23 (i.e., the barrel seat 23 is co-movable with the air pressure seat 6). It should be noted that one of the supporting holders integrated by the connecting tubes 71 and the holding member 81 is not communicated with the air pressure unit 6, the first and second filters 2, 3.

With the above description, the advantage of the cyclone filtering device according to the present disclosure can be summarized in the following:

1. Due to accumulation of larger and heavier substances in the dust collecting room 23 before the fluid flows through the second filter 3, only smaller and lighter substances would be trapped in the capture member 33, so that frequency of cleaning of the capture member 3 is reduced.

2. In comparison with the abovementioned prior art, the fluid is further filtered by the second filter 3 with the smaller and lighter substances being trapped by the capture member 33, so that the filtering effect and fluid cleanness are enhanced.

3. Arrangement of the connecting tubes 71, the coupling members 72, and the end covers 32 is adjustable according to factors such as fluid inflow/outflow, fluid cleanness, environmental, or spatial occupation.

4. The air pressure unit 6 has a relatively longer serving life since the fluid is effectively filtered before entering the air pressure unit 6.

5. During passage of the fluid through the first filter 2 and the second filter 3, the downward fluid-flowing direction ensures the flow of the fluid to be steady and smooth.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

What is claimed is:

1. A cyclone filtering device comprising:
a first filter including a first filtering tube that defines a first turbulence room, and that has two opposite first end portions, a coupling cover that removably covers said first filtering tube, a barrel seat that is disposed for said first filtering tube to extend thereinto, and an impeller that is mounted between said first filtering tube and said coupling cover, said coupling cover being removably connected to one of said first end portions of said first filtering tube, and having two cover openings that are communicated with said first turbulence room, and that are disposed for allowing passage of fluid, said barrel seat defining a dust collecting room that is communicated with said first turbulence room, the other one of said first end portions of said first filtering tube extending into said dust collecting room; and
a second filter connected to said first filter, and including a second filtering tube that defines a second turbulence room communicated with said first turbulence room, and that has two opposite second end portions, two end covers that removably and respectively cover said second end portions of said second filtering tube, and a capture member that is disposed in said second turbulence room of said second filtering tube, and that has a plurality of filtering nets disposed for capturing substances which are entrained in the fluid, each of said end covers having an end opening that is communicated with said second turbulence room.

2. The cyclone filtering device as claimed in claim 1, wherein said first filter further includes an annular dust output member, said barrel seat including a barrel body that defines a dust collecting room, and a barrel cover that is removably connected to said barrel body, and that is disposed for allowing said first filtering tube of said first filter to extend therethrough, said dust output member being connected to the other one of said first end portions that extends into said dust collecting room, and being communicated with said dust collecting room.

3. The cyclone filtering device as claimed in claim 1, further comprising a connecting unit for connecting said second filter to said first filter, said coupling cover further having two first flanges that respectively define said cover openings, each of said end covers having a second flange that defines a corresponding one of said end openings, said connecting unit including a plurality of coupling members, each of said coupling members being disposed for connecting one of said first flanges of said coupling cover to an adjacent one of said second flanges of said end covers.

4. The cyclone filtering device as claimed in claim 3, further comprising an air pressure unit configured as a blowing machine, and including an annular seat, a motor that is mounted to said annular seat, and two opening flanges that respectively define two air openings disposed for allowing the passage of the fluid, said annular seat having a passage that is communicated with said air openings.

5. The cyclone filtering device as claimed in claim 4, wherein:
said connecting unit further includes a plurality of connecting tubes, each of which has two connecting tube flanges respectively formed at two opposite ends thereof; and
each of said coupling members is connected between one of said connecting tube flanges of said connecting tubes and an adjacent one of said opening flanges of said air pressure unit, is connected between one of said connecting tube flanges of said connecting tubes and an adjacent one of said second flanges of said end covers, or is connected between one of said first flanges of said coupling cover and the adjacent one of said second flanges of said end covers.

6. The cyclone filtering device as claimed in claim 5, wherein:
said connecting unit further includes a plurality of coupling tubes, a plurality of extending tubes and a plurality of three-way tubes;
each of said coupling tubes has a coupling tube flange formed at one end thereof;
each of said extending tubes has two extending tube flanges formed at two opposite ends thereof, and respectively connected to two coupling tubes;
each of said three-way tubes has three-way tube flanges respectively formed at three ends thereof; and
each of said coupling members is connected between said coupling tube flange of one of said coupling tubes and an adjacent one of said extending tube flanges of said extending tubes, is connected between said coupling tube flange of one of said coupling tubes and an adjacent one of said first flanges of said coupling cover, or is connected between one of said three-way tube flanges of said three-way tubes and an adjacent one of said extending tube flanges of said extending tubes.

7. The cyclone filtering device as claimed in claim 6, further comprising a supporting frame unit including a holding member that is mounted onto said connecting unit, and that is disposed for holding said barrel seat such that said barrel seat is disposed above said air pressure unit.

8. The cyclone filtering device as claimed in claim 7, wherein:
said supporting frame unit further includes a plurality of plugs each plugged into a corresponding one of said connecting tube flanges of said connecting tubes, and a handle connected to said holding member;
each of said plugs has a plug flange and a plug body, said holding member being disposed around and abutting against said plug bodies of said plugs; and
each of said coupling members is connected between said plug flange of one of said plugs and an adjacent one of said extending tube flanges of said extending tubes, or between said plug flange of one of said plugs and an adjacent one of said three-way tube flanges of said three-way tubes.

9. The cyclone filtering device as claimed in claim 1, wherein the fluid sequentially flows through said first filter and said second filter, and into said air pressure unit.

10. The cyclone filtering device as claimed in claim 1, wherein:
said impeller of said first filter is disposed for separating the fluid and the substances entrained in the fluid so as to drive the substances to move in a substance-moving direction which is opposite to a fluid-flowing direction of the fluid; and
said capture member of said second filter is disposed for allowing for flow of the fluid therethrough, and capturing the substances thereon.
